(19) United States
(12) Patent Application Publication
(10) Pub. No.: US 2013/0006572 A1
(43) Pub. Date: Jan. 3, 2013

(54) Methods for detection of unique physical motions

(76) Inventor: David Hayner, (US)

(21) Appl. No.: 13/173,740

(22) Filed: Jun. 30, 2011

(51) Int. Cl. G06F 15/00; G01P 15/00

(52) U.S. Cl. 702/141

(57) ABSTRACT

Apparatus and methods for the generation, collection and use of specific user-induced motions of an appliance device and the use of the correspondence between these collected measures of user-induced motions and previously generated and possibly stored measures of user-induced motions of an appliance device are provided. This system includes methods for generating the stored measures of user-induced motions and for continuously updating these stored references.

### TECHNICAL FIELD

The disclosed subject matter generally relates to electronic devices, and more particularly relates to apparatus and methods for detection and classification of combinations angular and linear velocities or acceleration sequences.

### BACKGROUND

Sensor devices (e.g., accelerometers, gyroscopes, compasses or similar devices for measuring the Earth's magnetic field, pressure sensors, torque sensors, or the like) are mounted in appliances in order to measure the motions of the appliance. These motions may be the result of conscious physical movement of the appliance by the user relative to inertial space or relative to fixed external beacons. The Earth's magnetic field can be interpreted as one example of a fixed external beacon. Physical movements are generally comprised of combinations of linear and angular motions. Sensors can measure and allow recording of a measure of these physical motions. These physical motions can be used to provide a user interface to the appliance. Examples include portrait-landscape detection to alter the display on a screen as a function of orientation, or physical tapping of the appliance with a pen or finger as a substitute for a button actuation. Sensor measured physical motions can also be used to track the motion and orientation of the appliance in three-dimensional space. These recorded motions, or trajectories, can be unique to a given user and appliance.

Accordingly, it is possible to relate a specific trajectory to a given user moving an appliance in a specific and repeatable manner. This specific trajectory can then be used as a form of unique fingerprint for a given individual with a given appliance. This fingerprint can be used as a form of lock or security key to enable specific functions in the appliance or allow the appliance to aid the user in the accomplishment of a given task. Furthermore, other desirable features and characteristics of the embodiments presented here will become apparent from the subsequent detailed description and the appended claims, taken in conjunction with the accompanying drawings and this background.

### BRIEF DESCRIPTION OF THE DRAWINGS

Various embodiments will hereinafter be described in conjunction with the following figures, wherein like numerals denote like elements, and

FIG. 1 is a diagram of a set of sensors configured in accordance with one embodiment of the invention, in which an appliance includes sensors coupled with a processor, memory sub-system and optional user interface;

FIG. 2 is a diagram of a set of sensors configured in accordance with one embodiment of the invention, which includes sensors which are possibly aided by remote beacons, coupled with a processor, memory sub-system and optional user interface;

FIG. 3 is a diagram of an appliance and set of sensor devices configured in accordance with another embodiment of the invention, which comprises a sensor, possibly aided by external beacons, coupled with a processor, memory sub-system, optional user interface and communication system to enable transfer of data to and from remote data servers, third party devices and the appliance;

FIG. 4 is a schematic diagram that illustrates the signal flow operation of the system of FIGS. 1-3;

FIG. 5 is a sample reference signal forming part of a user reference metric in accordance with an embodiment of the invention;

FIG. 6 is a sample reference user input signal collected by the sensors forming part of a candidate user signal metric in accordance with an embodiment of the invention;

FIG. 7 is a sample user input signal collected by the sensors forming part of a rejected candidate user signal metric in accordance with an embodiment of the invention;

FIG. 8 is a schematic diagram that illustrates a basic training method for building the reference metrics;

FIG. 9 is a schematic diagram that illustrates an alternate embodiment of a training system for building the reference metrics.

### DETAILED DESCRIPTION OF EMBODIMENTS

The following detailed description is merely exemplary in nature and is not intended to limit the scope or the application and uses of the described embodiments. Furthermore, there is no intention to be bound by any theory presented in the preceding background or the following detailed description.

Various embodiments provide a set of sensor devices mounted in an appliance configured to measure various physical motions of the appliance by the user. These motions of the appliance, caused with intent by the user, will be referred to as user-induced motions of the appliance. These user-induced motions of the appliance are often measured as a set of linear angular motions of the appliance. The processor is used to record time sequences of these signals, and at the minimum, collect, format and communicate this information to other processes which may be either locally or remotely implemented. These other processes are employed to ascertain if the input combination of signals, hereafter referred to as signal vectors, correspond to one or more stored reference metrics. In some embodiments, certain characteristics of these input signal vectors may be employed to update or modify the stored reference metrics. In certain embodiments, all of this processing will occur in the user's appliance. In certain other embodiments, some or all of this processing may occur remotely.

The subject matter described here is particularly suitable for use with microelectromechanical systems (MEMS) based sensor devices, sensor elements, or sensor architectures, including, without limitation: MEMS based accelerometers, gyroscopes, pressure sensors, compasses, and the like. However, the application of the described subject matter is not limited to MEMS based sensors, and the techniques and technologies presented here could be equivalently deployed in other implementations and deployments. For example, the processes described here could be equivalently applied to bulk devices (such as a mechanical spinning gyroscope), to the next generation of solid state sensing devices, and/or to other sensor technologies that may be developed in the future.

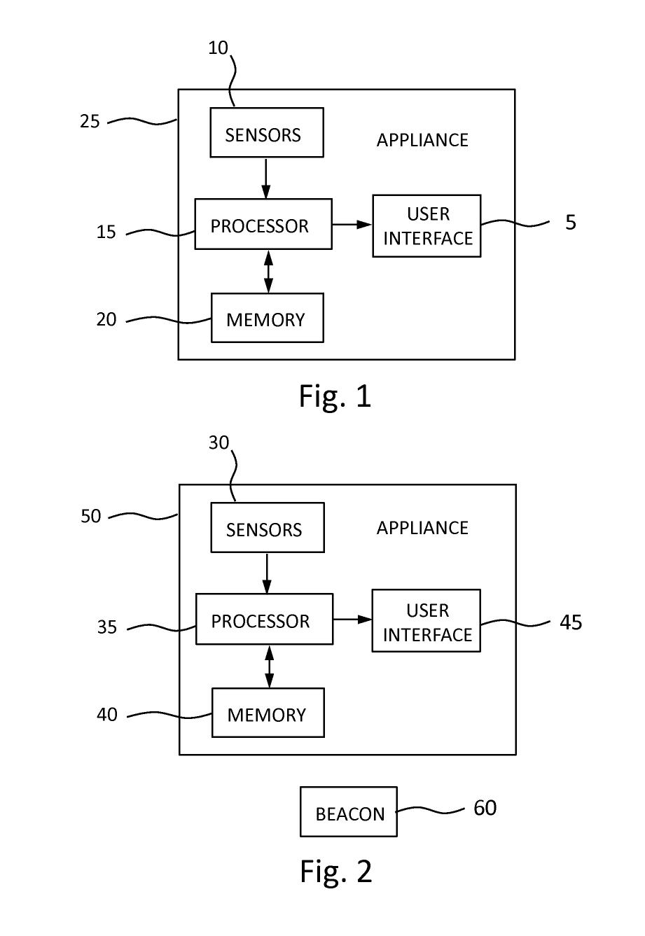

FIG. 1 is a diagram of one embodiment of an appliance device 25 including a plurality of sensors 10 that can be used to provide a measure of user-induced motions of the appliance device 25. In the illustrated embodiment, appliance device 25 comprises a set of sensors 10, a processor 15 with memory 20 and possibly a user interface 5. In various embodiments the processor 15, memory 20 and sensors 10 may be combined onto one or more physical die. In other embodiments, the processing actions implemented by processor 15 and memory 20 may be realized in hardwire logic, processors, analog circuits and combinations of these devices.

Processor device 15 may be any integrated circuit device configured for a particular purpose. As such, processor device 15 may be any application specific integrated circuit (ASIC) device known in the art or developed in the future.

Memory 20 is used to store reference data, software programs, intermediate data and other information and programs required to enable operation of the processor. Memory 20 is likely a combination of volatile and non-volatile memory.

User interface 5 is used to provide a source of feedback and control to the user of the appliance. This user interface 5 may be comprised of a display, touch panel, lights, speaker and/or microphone, buttons, actuators and other human interface devices.

Sensors 10 may be any device or combination of devices or systems that converts energy or a physical attribute into another type of energy or physical attribute for measurement purposes. In this regard, sensors 10 may include or cooperate with elements such as, without limitation: an accelerometer, a switch, an actuator, a gyroscope, a pressure measuring element, a compass (or similar device for measuring the Earth's magnetic field), or the like.

In practice, motions of the appliance 25 caused by user actions are measured by the sensors 10. A time sequence of the outputs of these sensors 10 is assembled into a signal vector. There is typically one signal vector for each axis of sensor sensitivity. As an example, the data from a 3-axis accelerometer may be arranged in an X acceleration signal vector, a Y axis acceleration signal vector and a Z axis acceleration signal vector. Signal vectors are processed individually or in combination in order to extract specific characteristics of the motion of the appliance 25. Examples of characteristics that may be extracted include frequency or energy information as a function of time, zero-crossing times, inflection points, cross-correlation coefficients between signal vectors, and many others. The characteristics extracted from a set of signal vectors are then compared to reference characteristic sets stored in memory. These comparisons are scored in any of a plurality of methods: Mean squared error, maximum error, time warping error, statistical, etc. A metric of these comparisons is created and analyzed to determine which, if any, of the reference sets the input is sufficiently similar. An example of a simple metric is a weighted sum of the comparisons and then a test if the sum meets a predefined threshold. Independent of the characteristics extracted, metrics and scoring methods used, the result is either to reject a match with any references or affirm a match with one of more specific references. This rejection or affirmation can be used by other systems to enable or block specific functions of the appliance 25 or in operations in remote systems. In some embodiments, results of this matching effort may be used to update one or more reference characteristic sets.

The previous discussion is not intended to limit the specific sets of extracted characteristics, the metrics calculated or the scoring methods used. References to specific techniques are used only as a means to explain an example of the art. Those skilled in these methods are aware of many alternate methods that can be employed.

FIG. 2 is a block diagram of an alternate embodiment of the appliance device 50 including a plurality of sensors 30, possibly aided by external beacon 60, which can be used to augment or provide measures of user-induced motions of the appliance 50. The signal vectors generated via assistance from the beacon may be in addition to signal vectors generated without the aid of a beacon. In the illustrated embodiment, appliance device 50 comprises a set of sensors 30, a processor 35 with memory 40 and possibly a user interface 45. In various embodiments the processor 35, memory 40 and sensors 30 may be combined onto one or more physical die. In other embodiments, the processing actions implemented by processor 35 and memory 40 may be realized in hardwire logic, processors, analog circuits and combinations of these devices.

External beacon 60 in FIG. 2 may be either a static non-cooperating source such as the Earth's magnetic field or a specific function beacon. Alternatively, this beacon may be a system designed to provide information, in either a cooperative or non-cooperative manner, to allow the appliance 50 to generate a measure of user-induced motion data via sensors 30. Independent of the source of the signal vectors, the various processes employed in this invention are designed to determine if this set of input vectors is a sufficiently good match to one or more references stored in memory.

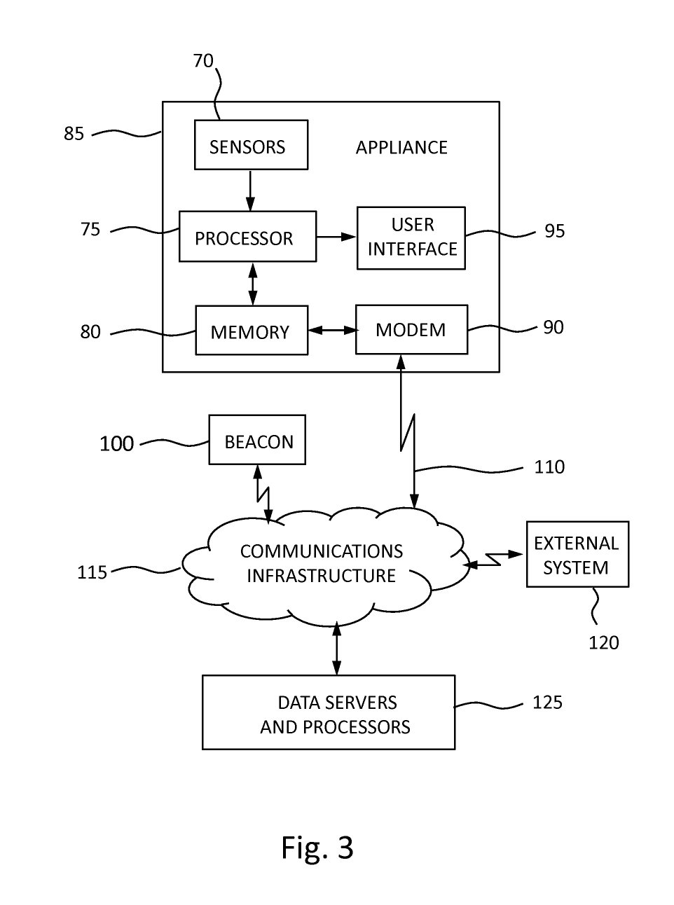

FIG. 3 is a block diagram of an alternate embodiment of the appliance device 85 including a plurality of sensors 70 that can be used to provide a measure of user-induced motions of the appliance 85. In the illustrated embodiment, appliance device 85 comprises a set of sensors 70, processor 75 with memory 80, possibly a user interface 95 and a communications modem 90. In one embodiment, the processing elements in appliance 85 perform the processing required to recognize or classify the set of collected signal vectors, derived from the user-induced motions of the appliance, as a sufficiently close match to one of more references stored in memory 80. In various alternate embodiments the processor 75, memory 80 and sensors 70 may be combined onto one or more physical die. In other embodiments, the processing actions implemented by processor 75 and memory 80 may be realized in hardwire logic, processors, analog circuits and combinations of these devices. The communications modem 90 interfaces to a variety of communication systems that are currently available or that may become available in the future. The embodiment in FIG. 3 is substantially the same as that in FIG. 1 or FIG. 2 with the addition of the communications link represented by modem 90 and the added capabilities discussed below.

Sensors 70 may also be comprised of receivers and/or transmitters configured in such a way as to acquire, or cause to be created, linear or angular position, velocity or acceleration data representing user-induced motions of the appliance 85 via the aid of external signals or a beacon 100. This data can be generated internally in appliance 85 by means of cooperative or non-cooperative beacon processing methods realized in processor 75 and memory 80. Alternately, the transmitters and receivers contained in sensors 70 may be used in cooperative on non-cooperative methods to generate the linear or angular position, velocity or acceleration data representing user-induced motions of the appliance 85 in external systems 120 and relayed to the appliance 85 by means such as the modem 55. In yet another embodiment, both the externally and internally generated linear or angular position, velocity or acceleration data representing user-induced motions of the appliance 85 can be communicated to the data servers and processors 125. The user-induced motions of the appliance 85 may be processed for a match to stored references in the data servers and processors 125.

The embodiment in FIG. 3 supports yet another alternate realization in which the comparison of user-induced motion inputs to stored references may be performed remotely from the appliance 85. In this embodiment, the appliance 85 is a device used to cause the collection of user motions. The actual collection of this data may occur in beacon 100 or external system 120 which can communicate this data to the data servers and processors 125 for recognition processing via the communications infrastructure 115. Alternately, the appliance 85 may be the direct source of the data representing user-induced motions of the appliance and cause this data to be transmitted to the data servers and processors via use of the processor 75, memory 80, modem 90 and communications infrastructure 115. In either of these cases just described the recognition or classification of a specific motion as an element in stored references occurs remotely from the appliance 85. In addition, the recognition or classification can be performed in a combination of remote processing in 125 and local processing in appliance 85. In these cases, appliance 85 is the proximate source of user-induced motions which are used in this recognition process. This affirmation of a match can be used internally to the appliance 25, 50, or 85, in the data servers and processors 125, or in virtually any remote external system 120, or in any combination of these systems.

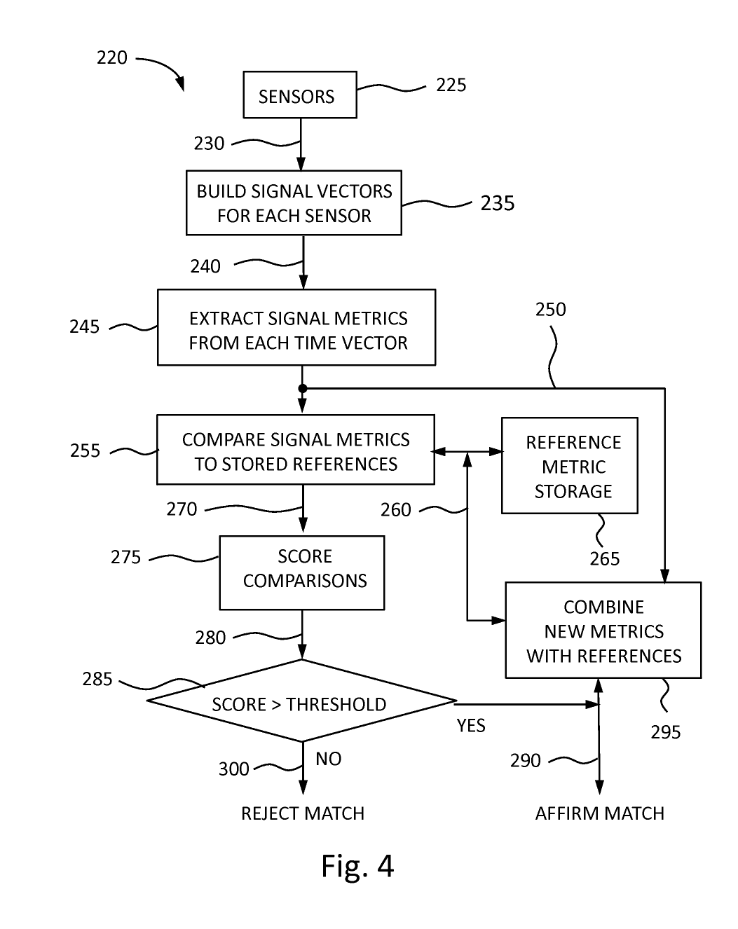

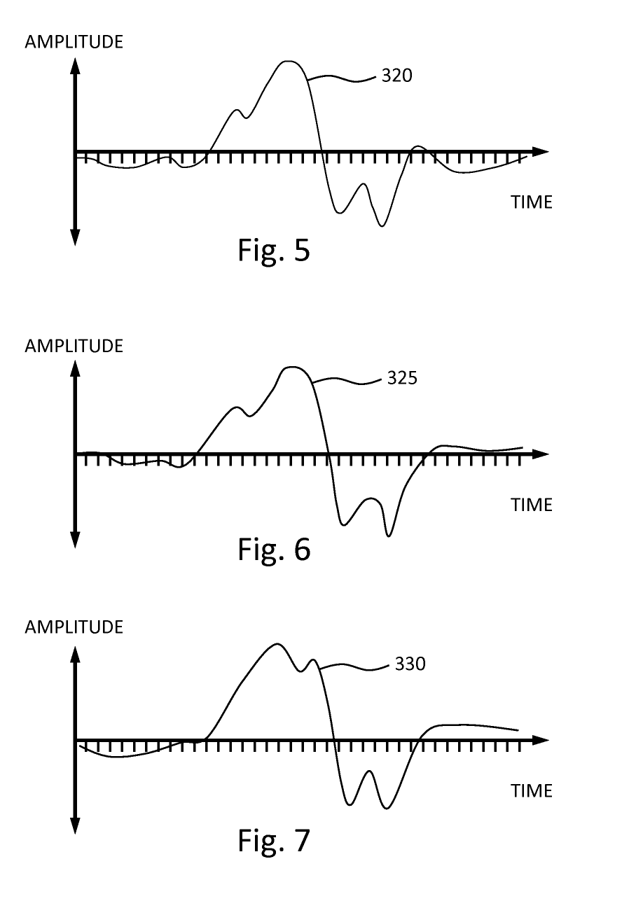

FIG. 4 illustrates the basic generation of signal vectors and operations on signal vectors realized by this invention. These operations may occur entirely in the appliance (25, 50 or 85), entirely in the data servers and processor 125, or in some combination of physical systems and locations without impacting the essential elements of this invention. Data collected by sensors 225 represents some combination of linear or angular position, velocity and acceleration data in either an inertial mode or in referenced to external beacons or some combination of both. The data 230, transmitted to block 235 captures the user-induced motions of the appliance 25, 50 or 85. In block 235, this data is collected and formed into time indexed vectors as illustrated in FIG. 5. We refer to these as signal vectors. For example, samples of the X axis acceleration data are collected at the sample rate of the sensors and appended into a vector of time consecutive samples for further processing. The signals represented at 240 are the signal vectors from multiple sensors. For example, there could be X, Y and Z axis angular rate data vectors of 50 samples each communicated from block 235 to block 245. In block 245, these vectors are processed individually or in combination to extract various metrics capturing features of the time vectors required by recognition or classification processes. Examples of these metric include signal content in specific frequency bands as a function of time, zero crossing times, total energy of X, Y and Z accelerometer signals as a function of time, cross-correlations between various time vectors. There is a large variety of potential metrics obvious to those skilled in these arts.

Stored in Reference Metric Storage 265 are one or more sets of metrics corresponding to specific user-induced motions of the appliance (25, 50 or 85). There may be several sets of metrics for matching to one of several possible user-induced motion data sets, 240. Block 255 calculates a measure of similarity (or difference) between the metrics from a user input and some set of those stored in the reference metric storage 265. The output 270 of this process is a set of measures relating the similarity (or difference) between the user input and the stored references. In block 275, these sets of measures are scored or weighted in some manner to emphasize certain features. Ultimately, this score is compared to a predefined set of criteria (a threshold test is a simple example) in block 285. The output of this block is either to reject or affirm a match. This process may compare a given set of metrics from a single user-induced motion of the appliance with one or more reference metrics stored in 265. In the example illustrated in FIG. 4, the affirm result is used to enable some form of combining the latest validated user input with the stored reference metrics via block 295. This is an optional operation. Further, it may be desirable to also use invalidated user inputs to update certain parameters in this process.

The affirm or reject result of block 285 may be used in any number of ways. In one embodiment, this result is used internally in the appliance (25, 50 or 85) to enable or disable certain functions. Alternately, as illustrated in FIG. 3, this result may be communicated to other external systems 220 to enable or disable certain operations.

FIG. 5 is a signal vector corresponding to one or more specific stored reference metrics. Signal 320 is composed of samples of a given sensor in a specific axis (e.g., the Z gyroscope output) as a function of time or sample index.

FIG. 6 is an input signal vector corresponding to a signal vector that would be successfully matched by one or more reference metrics. As in FIG. 5, signal 325 is composed of samples of a given sensor in a specific axis (say the Z gyroscope output) as a function of time or sample index.

FIG. 7 is an input signal vector corresponding to a signal vector that would not be successfully matched to one or more reference metrics. As in FIG. 5, signal 325 is composed of samples of a given sensor in a specific axis (e.g., the Z gyroscope output) as a function of time or sample index.

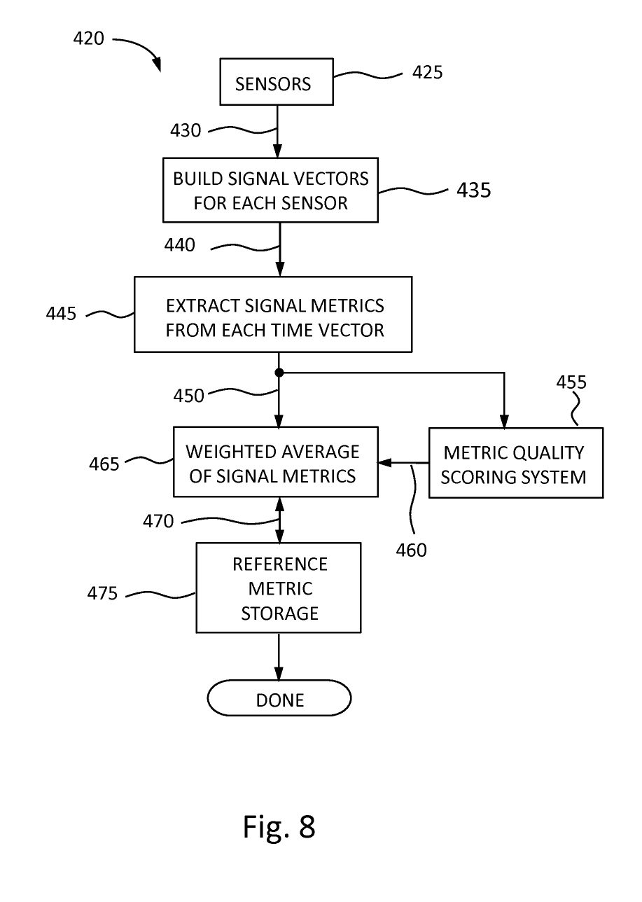

Illustrated in FIG. 8 is one embodiment of a training system, or method by which reference metrics are generated. The user is prompted to move the appliance (25, 50 or 85) in some readily repeatable pattern, multiple times in some cadence, possibly prompted by SW running in the appliance (25, 50 or 85). Sensors 425 collect this information which is relayed via connection 430 to block 435 in which these data values are arranged into signal vectors 440. For each of set of signal vectors corresponding to an individual execution of the pattern, signal metrics are extracted in block 445. In block 455, some measure of the quality of the signal metrics is generated. This quality vector is communicated to block 465 over connection 460. In block 465 recently generated signal metrics are combined in some manner (weighted averaging is one example) with previously collected signal metric references stored in block 475. At the conclusion of this operation on some set of input patterns, the final reference is stored in 475 for use in the recognition system. The decision to conclude this training session may be made simply on some number of patterns collected, a measure of some statistical measure of the difference in signal metrics, or any of a number of other techniques familiar to those skilled in these arts.

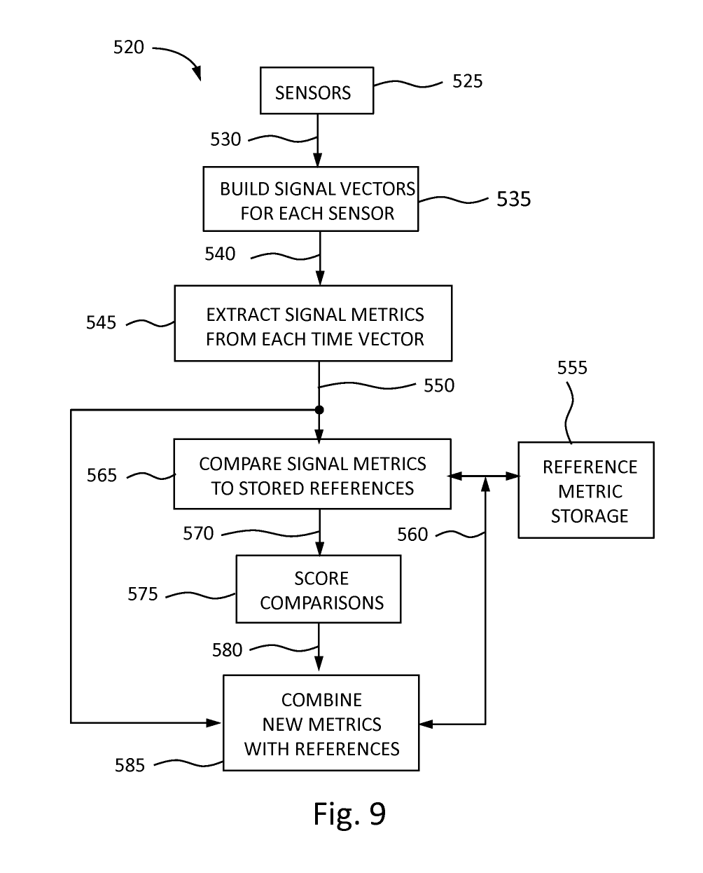

FIG. 9 illustrates an alternative embodiment of a training system, or method by which reference metrics are generated. As in the previous case illustrated in FIG. 8, the user is prompted to move the appliance (25, 50 or 85) in some readily repeatable pattern, multiple times in some cadence, possibly prompted by SW running in the appliance (25, 50 or 85). Sensors 525 collect this information which is relayed via connection 530 to block 535 in which these data values are arranged into signal vectors 540. For each set of signal vectors corresponding to an individual execution of the pattern, signal metrics are extracted in block 545. The extracted signal metrics 550 are compared against stored reference metrics 560 in block 565. The initial reference metrics may be some set of selected input sequences from the user. Comparison methods can include point-by-point differences, differences after time warping, sums of absolute values of differences, squared error, maximum and/or minimum errors and possibly other methods typically employed by those skilled in these arts. These comparisons are scored or weighted in some manner to generate a comparison vector at 580. This comparison vector is used in block 585 to drive the combining of the recently generated signal metrics with existing reference metrics stored in 555. As in the previous embodiment, the decision to conclude this training session may be made simply on some number of patterns collected, a measure of some statistical measure of the difference in signal metrics, or any of a number of other techniques familiar to those skilled in these arts.

There are no limitations as to the physical locations of the processing employed to generate these reference metrics. In manners similar to the recognition process, these training processes can be realized in the appliance, 25, 50 or 85 or in the data servers and processor 125 or in combinations of both. Beacons may or may not be employed to aid in the generation of the user-induced motions employed for the generation of reference metrics.

In summary, systems, devices, and methods configured in accordance with exemplary embodiments relate to:

An appliance device comprising a user interface, a set of sensors configured to generate a set of measures of the user-induced motion of the appliance that is indicative of the movements of the appliance and a processing and memory subsystem, possibly driven by software, coupled to the sensor set. The processing system is configured to receive the sensor outputs, and to determine if the signal measures generated by a user-induced motion of the appliance correspond to similar motions previously stored in the appliance. In the case of determining a sufficiently high degree of correspondence between the user-induced motions of the appliance and stored references, certain operations in the appliance may be enabled or disabled. In certain embodiments, the sensors may be one of an accelerometer, a gyroscope, a compass, and/or a pressure sensor.

The appliance device described in the previous paragraph in which external beacons may be used to aid in the detection of user-induced motions of the appliance.

The appliance device described above in which a communications modem is provided enabling the appliance to transmit results of the correspondence and control actions in remote systems.

The appliance device described above in which a communications modem is provided enabling the appliance to interact with cooperative on non-cooperative beacons.

The appliance device described above in which a communications modem is provided enabling the appliance to communicate the signal measures regarding user-induced motions of the appliance to remote systems in which the remote systems performs the analysis to determine if these user-induced motions of the appliance correspond to similar motions previously generated with the appliance. Alternately, this processing may occur in combinations of the appliance and remote systems. In the case of determining a sufficiently high degree of correspondence between the user-induced motions of the appliance and stored references for this motion, certain operations in the appliance or in remote systems can be enabled or disabled.

The appliance device described above in which the appliance is simply an aid in collecting user-induced motions of the appliance and the majority of processing is performed in remote systems.

The appliance device described above configured to enable the recording and generation of reference metrics corresponding to specific user-induced motions of the appliance.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An appliance device, comprising:
data processing devices;
a set of sensors coupled to the data processing and configured to generate an output corresponding to the user-induced motions of the appliance;
volatile and non-volatile memory systems coupled to the data processing devices and used for storing reference metrics corresponding to some measures of select user-induced motions of the appliance and possibly for storing software program instructions used by the data processor;
data processing methods to determine if the sensor collected measures of user-induced motions of the appliance correspond with one or more stored references in the appliance;
methods to employ the result of this correspondence to control certain actions in the appliance.

2. The appliance device of claim 1, augmented by external beacons to allow appliance sensor devices to collect data regarding the user-induced motions of the appliance which may be used by the appliance to determine if the user-induced motions of the appliance correspond to one of more stored references in the appliance memory.

3. The appliance device of claim 1, enabled with methods to allow users to generate specific reference metrics for specific user-induced motions of the appliance.

4. An appliance device, comprising:
data processing devices;
a set of sensors coupled to the data processing and configured to generate an output corresponding to the user-induced motions of the appliance;
volatile and non-volatile memory systems coupled to the data processing devices and used for storing reference metrics corresponding to some measures of select user-induced motions of the appliance and possibly for storing software program instructions used by the data processor;
communications devices coupled to the data processing devices allowing the appliance to communicate with external networks and systems;
data processing methods to determine if the sensor collected measures of user-induced motions of the appliance correspond with one or more stored references in the appliance memory;
methods to employ the result of this correspondence to control actions in this appliance and/or actions in external systems which can be accessed via the communications modem.

5. The appliance device of claim 4, wherein external beacons can interact in cooperative or non-cooperative methods with the appliance, possibly via the communications interface, for the generation of measures of user-induced motion of the appliance which may be used by the appliance to determine if the user-induced motions of the appliance correspond to one or more previously generated references stored in the appliance memory.

6. The appliance device of claim 4, wherein measures of user-induced motion of the appliance device, both those collected directly by the appliance as well as those collected externally to the device, are employed in external systems to determine if the collected measures of user-induced motions of the appliance correspond with one or more previously generated references.

7. The appliance device of claim 4, wherein measures of user-induced motion of the appliance device, both those collected directly by the appliance as well as those collected externally to the device, are employed in both the appliance and in external systems to determine if the collected measures of user-induced motions of the appliance correspond with one or more previously generated references. The results of this comparison can be used internal to the appliance to enable or disable certain operations and/or external to the appliance to enable or disable certain operations. These references may be stored in the appliance memory or the external system or in combinations of both.

8. The appliance device of claim 4, enabled with methods to allow users to generate specific reference metrics for specific user-induced motions of the appliance. These references may be stored in the appliance memory or the external system or in combinations of both.

9. A system, comprising at least:
a user appliance device containing active and/or passive elements and augmented by external beacons, communicating to various external systems (to the appliance) the generate outputs corresponding to the user-induced motions of the device;
external systems enabled by methods to determine if the user-induced motions of the appliance correspond to one or more previously generated references;
external systems which can communicate with yet additional external systems to enable or disable certain operations as a result of the correspondence between user-induced motion of the appliance and previously stored references.
